(19) United States
(12) Patent Application Publication
(10) Pub. No.: US 2023/0022214 A1
(43) Pub. Date: Jan. 26, 2023

(54) METHOD OF CONTROLLING DISPLAY DEVICE AND DISPLAY DEVICE

(71) Applicant: SEIKO EPSON CORPORATION, Tokyo (JP)

(72) Inventors: Toshiki FUJIMORI, Chino-shi (JP); Masataka MIYAMOTO, Matsumoto-shi (JP)

(21) Appl. No.: 17/869,043

(22) Filed: Jul. 20, 2022

(30) Foreign Application Priority Data
Jul. 20, 2021 (JP) 2021-119418

(51) Int. Cl. G06F 3/04845; H04N 9/31

(52) U.S. Cl. CPC G06F 3/04845; H04N 9/3188

(57) ABSTRACT

A method of controlling a display device includes the steps of displaying a first image in a first size on a display surface, displaying the first image and a second image which has the first size and is different from the first image on the display surface when an operation of changing a size of the first image is started, displaying the first image in the first size on the display surface when the operation continues, displaying the second image in a size different from the first size on the display surface based on the operation when the operation continues, and displaying the first image in a second size based on the operation on the display surface when the operation terminates.

The present application is based on, and claims priority from JP Application Serial Number 2021-119418, filed Jul. 20, 2021, the disclosure of which is hereby incorporated by reference herein in its entirety.

### BACKGROUND

### 1. Technical Field

The present disclosure relates to a method of controlling a display device and a display device.

### 2. Related Art

In the past, there has been known a technology of changing a display magnification of an image to be displayed on a display surface. For example, JP-A-2017-111628 discloses a projector which changes the zoom magnification of an input image in accordance with an operation on a menu bar.

However, in the case of a configuration of receiving the operation on the menu bar to gradually increasing the display size of the image, there is a problem that the visibility of the image deteriorates on the way of gradually enlarging the image.

### SUMMARY

An aspect of the present disclosure is directed to a method of controlling a display device including displaying a first image in a first size on a display surface, displaying the first image and a second image which has the first size and is different from the first image on the display surface when an operation of changing a size of the first image is started, displaying the first image in the first size, and displaying the second image in a second size different from the first size based on the operation of changing the size of the first image when a detection of the operation continues, and displaying the first image in the second size when the detection of the operation terminates.

An aspect of the present disclosure is directed to a display device including display, a detector configured to detect an operation to a display surface, and a controller configured to output a first image and a second image to the display, wherein the controller is configured to execute outputting the first image to the display, outputting the first image and the second image which has the first size and is different from the first image to the display when the detector detects an operation of changing a size of the first image, outputting the first image in a first size to the display, and outputting the second image in a second size different from the first size to the display based on the operation when the detector continuously detects the operation, and outputting the first image to the display after changing the size of the first image from the first size to the second size when the operation terminates.

### BRIEF DESCRIPTION OF THE DRAWINGS

FIG. 1 is a front view showing an installation condition of a projector.

FIG. 2 is a side view showing the installation condition of the projector.

FIG. 3 is a block diagram showing a schematic configuration of the projector.

FIG. 4 is a block diagram showing a schematic configuration of an image projector.

FIG. 5 is a diagram showing an example of projection image.

FIG. 6 is a diagram showing a state is which an expansion button is operated, and a frame image is displayed.

FIG. 7 is a diagram showing a state in which a display size of the frame image is increased.

FIG. 8 is a diagram showing a state of enlarging the display image so as to match the resolution of a display image with the display size of the frame image.

FIG. 9 is a diagram showing a state in which the display size of the frame image is decreased.

FIG. 10 is a diagram showing a state of reducing the display image so as to match the resolution of the display image with the display size of the frame image.

FIG. 11 is a diagram showing a thumbnail displayed on a projection surface.

FIG. 12 is a diagram showing the projection surface on which a movement operation has not been performed.

FIG. 13 is a diagram showing the projection surface on which the movement operation has been performed.

FIG. 14 is a flowchart showing an overall operation of the projector.

FIG. 15 is a flowchart showing the details of the step S6.

FIG. 16 is a flowchart showing the details of the step T5.

FIG. 17 is a flowchart showing the details of the step T9.

FIG. 18 is a flowchart showing the details of the step T11.

### DESCRIPTION OF AN EXEMPLARY EMBODIMENT

An embodiment of the present disclosure will hereinafter be described with reference to the accompanying drawings.

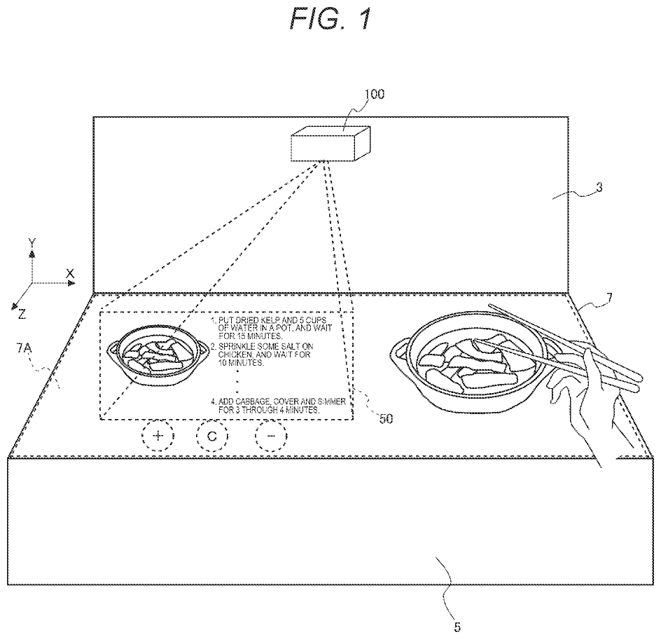

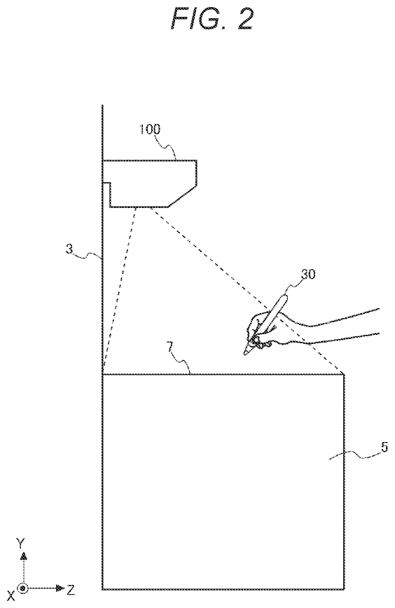

FIG. 1 and FIG. 2 are diagrams showing an example of an installation condition of a projector 100.

FIG. 1 is a front view of the projector 100 viewed from the front, and FIG. 2 is a side view of the projector 100 viewed from a lateral side. An X axis shown in FIG. 1 and FIG. 2 corresponds to a left-right direction, a Y axis corresponds to a vertical direction, and a Z-axis direction corresponds to a front-back direction.

The projector 100 is fixed to a wall surface 3 in a cooking area, and projects image light toward a top surface 7 of a cooking table 5 installed below the projector 100. Thus, on the top surface 7, there is displayed a projection image 50 which is an image based on the image light. The top surface 7 of the cooking table 5 is used as a projection surface 7A on which the projector 100 projects the image light. The projection surface 7A corresponds to a display surface.

In the projector 100, a projection range is adjusted so that the image light can be projected on the entire area of the surface 7. Further, due to an operation by the user, it is possible for the projector 100 to expand, reduce, and move the range in which the image light is projected. For example, it is possible for the user to operate a light emitting pen 30 to make the projector 100 project the image light on a part of the projection surface 7A to perform a work such as cooking using an area of the top surface 7 on which the image light is not projected.

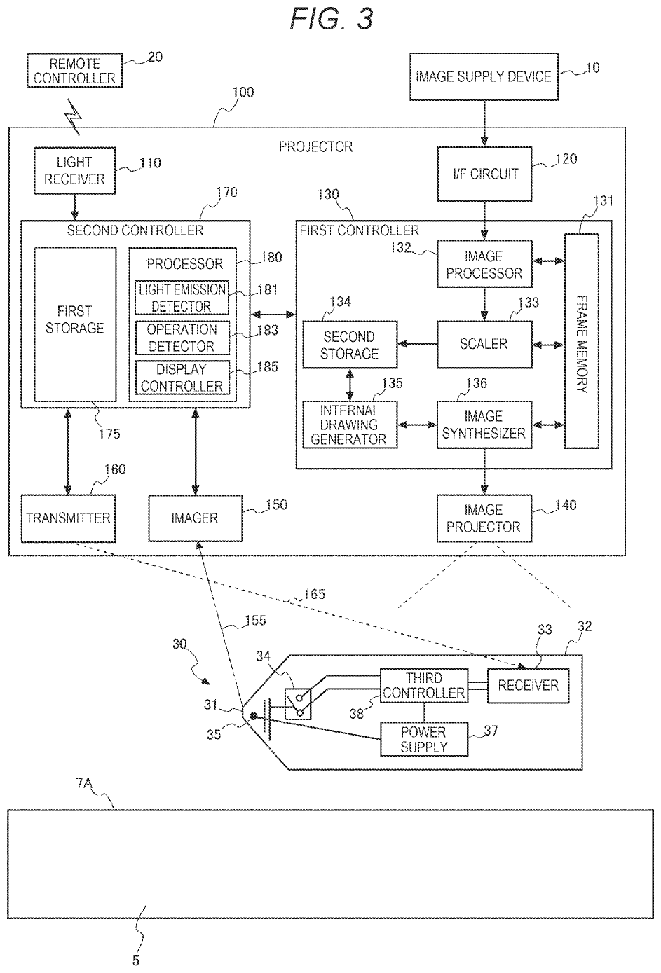

FIG. 3 is a block diagram showing a schematic configuration of the projector 100.

The configuration of the projector 100 will be described with reference to FIG. 3.

The projector 100 is provided with a light receiver 110, an I/F circuit 120, a first controller 130, an image projector 140, a transmitter 160, an imager 150, and a second controller 170. Further, the first controller 130 is provided with a frame memory 131, an image processor 132, a scaler 133, a second storage 134, an internal drawing generator 135, and an image synthesizer 136.

The light receiver 110 receives an infrared signal transmitted from a remote controller 20. The light receiver 110 outputs an operation signal corresponding to the infrared signal thus received to the second controller 2. The operation signal is a signal corresponding to a switch of the remote controller 20 operated.

The I/F circuit 120 is coupled to an image supply device 10 with a cable to receive an image signal supplied from the image supply device 10. The image supply device 10 corresponds to an external device. The I/F circuit 120 retrieves image data and sync signals included in the image signal thus received. The I/F circuit 120 outputs the image data and the sync signals thus retrieved to the first controller 130, and outputs the sync signals thus retrieved to the second controller 170. The image signal corresponds to an input signal. The first controller 130 processes the image data included in the image signal frame by frame in sync with the sync signals thus input. The second controller 170 controls constituents of the projector 100 in sync with the sync signals input. The image signal can be data of a moving image, or can also be data of a still image. Further, the resolution of the image data included in the image signal is a first resolution. The first resolution is a resolution such as full-HD or 4K.

Then, the first controller 130 will be described.

The frame memory 131 is formed of a memory such as a RAM (Random Access Memory). The image processor 132 develops the image data which is input from the I/F circuit 120, on the frame memory 131, and performs a variety of types of image processing on the image data developed based on the control by the second controller 170. For example, the image processor 132 performs the processing such as adjusting the brightness and the contrast of the image, and adjusting a color mode. The first controller 130 corresponds to a controller.

The color mode is a mode for adjusting a color tone of the image to be displayed on the projection surface 7A. For example, as color modes, the projector 100 is provided with a dynamic mode suitable for viewing and listening in a bright environment, a living mode suitable for viewing and listening in the half-light, a theater mode suitable for movie viewing under a dark environment. To the image processor 132, there input a correction parameter corresponding to the color mode from the second controller 170. The image processor 132 uses the correction parameter thus input to perform a correction such as a gamma correction on the image data developed on the frame memory 131 to thereby adjust the color mode of the image data.

The scaler 133 converts the resolution of the image data developed on the frame memory 131 in accordance with the control by the second controller 170. For example, there is performed a scaling process of converting a size of the image data into a resolution suitable for the display size of the projection image 50. The image data generated by the scaling process is referred to as a conversion image. The scaler 133 stores the conversion image thus generated in the second storage 134. The conversion image stored in the second storage 134 is updated by the scaler 133. When new image data is input from the image processor 132, the scaler 133 executes the scaling process on the image data thus input, and stores the conversion image generated by the scaling process in the second storage 134 to update the conversion mage. The resolution of the conversion image is a second resolution.

The second storage 134 is formed of, for example, a nonvolatile memory. The second storage 134 stores the conversion image and an OSD (On-Screen Display) image on which the scaling process has been performed by the scaler 133. The OSD image includes an image of an operator such a pointer displayed at an indication position, operation buttons 55 described later.

The internal drawing generator 135 is provided with a GPU (Graphics Processing Unit). The internal drawing generator is provided with a function of converting the resolution of the conversion image stored in the second storage 134 to change the size of the image to be displayed on the projection surface 7A in accordance with the control by the second controller 170.

The internal drawing generator 135 converts the resolution of the conversion image into a resolution corresponding to a display size set by the operation of the light emitting pen 30. It is possible for the user to operate the light emitting pen 30 to expand or reduce the size of the image to be displayed on the projection surface 7A.

Further, the internal drawing generator 135 reads out the conversion image, or the conversion image and the OSD image from the second storage 134 in accordance with the control by the second controller 170. Further, to the internal drawing generator 135, there is input drawing data generated by the second controller. The internal drawing generator 135 converts the resolution of the conversion image and the OSD image thus retrieved, and then outputs the conversion image and the OSD image thus converted and the drawing data to the image synthesizer 136 in accordance with the control by the second controller 170. On this occasion, coordinate information representing the coordinate in the frame memory 131 input from the second controller 170 is also output by the internal drawing generator 135 to the image synthesizer 136. The coordinate information represents the coordinates where the conversion image, the OSD image, and the drawing data are developed.

The image synthesizer 136 develops the conversion image, the OSD image, and the drawing data thus input at the coordinates in the frame memory 131 represented by the coordinate information input from the internal drawing generator 135 to generate the display data to be displayed on the projection surface 7A in accordance with the control by the second controller 170. The image synthesizer 136 reads out the display data developed on the frame memory 131, and then outputs the display data thus read out to the image projector 140.

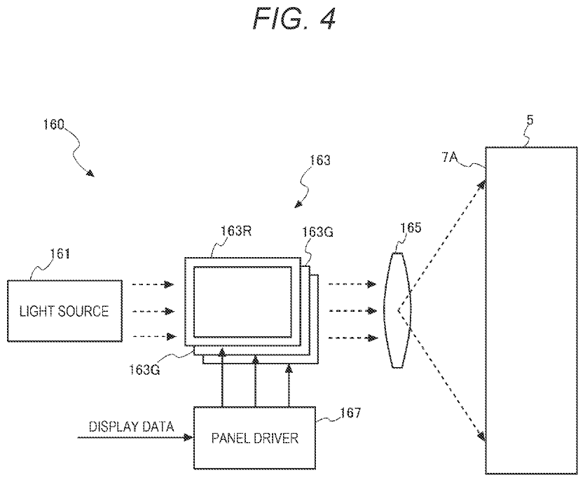

FIG. 4 is a diagram showing an example of a configuration of the image projector 140.

The configuration of the image projector 140 will be described with reference to FIG. 4. The image projector 140 corresponds to a display.

The image projector 140 is provided with a light source 141, three liquid crystal panels 143R, 143G, and 143B as a light modulation device 143, an optical unit 145, and a panel driver 147.

The image projector 140 modulates the light emitted from the light source 141 to generate the image light, and then projects the image light thus generated in an enlarged manner with the optical unit 145.

The light source 141 includes a discharge type light source lamp such as a super high-pressure mercury lamp or a metal halide lamp, or a solid-state light source such as a light emitting diode or a semiconductor laser. The light emitted from the light source 141 enters the liquid crystal panels 143R, 143G, and 143B. The liquid crystal panels 143R, 143G, and 143B are each formed of a transmissive liquid crystal panel having a liquid crystal material encapsulated between a pair of transparent substrates, and so on. The liquid crystal panels are each provided with a pixel area constituted by a plurality of pixels arranged in a matrix, and are each arranged so that a drive voltage can be applied to the liquid crystal material pixel by pixel.

The panel driver 147 applies the drive voltages corresponding to the display data thus to the respective pixels in the pixel area to thereby set the pixels to respective light transmittances corresponding to the display data. The light emitted from the light source 141 is transmitted through the pixel area of each of the liquid crystal panels 143R, 143G, and 143B to thereby be modulated pixel by pixel, and thus the image light corresponding to the display data is formed for each of the colored light beams. The image light beams as the image light of the respective colors thus formed are combined with each other pixel by pixel by a color combining optical system not shown to thereby turn to the image light representing a color image, and the image light is then projected on the projection surface 7A by the optical unit 145 in an enlarged manner.

The imager 150 is a camera provided with an imaging element not shown such as a CCD (Charge Coupled Device) sensor or a CMOS (Complementary Metal Oxide Semiconductor) sensor. The imager 150 has an infrared transmission filter for absorbing visible light and transmitting infrared light, and images the infrared light emitted from the light emitting pen 30 via the infrared transmission filter. The imager 150 repeats imaging of a range including the projection surface 7A based on the control by the second controller 170, and then sequentially outputs taken images as an imaging result to the second controller 170.

The transmitter 160 outputs first signal light 165 for synchronizing light emission timing of the light emitting pen 30 with imaging timing of the imager 150. The first signal light 165 is represented by a dotted line in FIG. 3. The first signal light 165 is a signal of near-infrared light which can be received by a receiver 33 of the light emitting pen 30. The transmitter 160 periodically transmits the first signal light 165 during the operation of the projector 100.

The first signal light 165 is a control signal for designating a timing for, for example, making the light emitting pen 30 transmit second signal light 155. The second signal light 155 is near-infrared light having a predetermined light emission pattern. In FIG. 3, the second signal light 155 is represented by a dashed-dotted line. The light emitting pen 30 transmits the second signal light 155 in sync with, for example, the timing at which the first signal light 165 is received. Therefore, it becomes possible for the projector 100 to make the imager 150 execute imaging in sync with the timing at which the light emitting pen 30 emits the second signal light 155. The transmitter 160 is provided with a light source such as an LED (Light Emitting Diode), and a device for controlling lighting and extinction of the light source. The device for performing the control can be formed of, for example, an ASIC (Application Specific Integrated Circuit) or an FPGA (Field-Programmable Gate Array).

Here, a configuration of the light emitting pen 30 will be described.

The light emitting pen 30 is provided with a tip 31, a shaft 32, the receiver 33, a tip switch 34, a light emitter 35, a power supply 37, and a third controller 38.

The receiver 33 includes a light receiving element for receiving the infrared light and so on, and receives the first signal light 165 transmitted by the projector 100. The receiver 33 outputs a control signal representing the timing at which the first signal light 165 is received and so on to the third controller 38.

The tip switch 34 is a switch which turns ON when the tip 31 makes contact with the projection surface 7A and thus the tip 31 is held down, and turns OFF when the contact between the tip 31 and the projection surface 7A is released.

The light emitter 35 includes an LED for emitting the near-infrared light, and is controlled in light emission by the third controller 38, and emits the second signal light 155 as the near-infrared light.

The power supply 37 is provided with a battery such as a primary cell, a secondary cell, or a photoelectric cell, and supplies the constituents of the light emitting pen 30 with electrical power. The light emitting pen 30 can also be provided with a power switch for switching ON/OFF the power supply from the power supply 37.

The third controller 38 is provided with a processor such as a CPU (Central Processing Unit), a memory device such as a memory, and a variety of peripheral circuits. In other words, the third controller 38 is provided with a function as a computer. The third controller 38 controls the constituents of the light emitting pen 30 by the processor executing a program stored in the storage device. Further, the third controller 38 can have a configuration provided with a plurality of processors.

The third controller 38 decides a light emission timing for making the light emitter 35 emit light based on the first signal light 165 received by the receiver 33. The third controller 38 makes the light emitter 35 emit light at a light emission timing thus decided to output the second signal light 155.

The configuration of the projector 100 will continuously be described.

The second controller 170 is a computer device provided with a first storage 175 and a processor 160. The second controller 170 performs overall control of an operation of the projector 100 by the processor 180 operating in accordance with a control program stored in the first storage 175.

The first storage 175 is provided with a memory such as a RAM and a ROM (Read Only Memory). The RAM is used for a temporary storage of a variety of types of data, and the ROM stores the control program for controlling the operation of the projector 100, a variety of types of configuration information and so on.

The first storage 175 stores calibration data. The calibration data is data in which the coordinate in the taken image of the imager 150 and the coordinate in the frame memory 131 are made to correspond to each other. In each of the taken image and the frame memory 131, there is set the two-dimensional coordinate system, and thus, the coordinate in the frame memory 131 corresponding to the coordinate on the taken image is uniquely identified by the calibration data.

The image processor 132, the scaler 133, the internal drawing generator 135, the image synthesizer 136, and the processor 180 are each an arithmetic processing device constituted by a CPU or an MPU (Micro Processing Unit). The image processor 132, the scaler the internal drawing generator 135, the image synthesizer 136, and the processor 180 execute the control program to control the constituents of the projector 100. The image processor 132, the scaler 133, the internal drawing generator 135, the image synthesizer 136, and the processor 160 can be formed of a single processor, or can also be formed of a plurality of processors. Further, the image processor 132, the scaler 133, the internal drawing generator 135, the image synthesizer 136, and the processor 180 can be formed of an SoC (system-on-a-chip) integrated with a part or the whole of the first storage 175, a part or the whole of the second storage 134, and other circuits. Further, the image processor 132, the scaler the internal drawing generator 135, the image synthesizer 136, and the processor 180 can also be formed of a combination of a CPU for executing a program and a DSP (Digital Signal Processor) for executing predetermined arithmetic processing. Further, it is also possible to adopt a configuration in which all of the functions of the image processor 132, the scaler 133, The internal drawing generator 135, the image synthesizer 136, and the processor 180 are implemented in the hardware, or it is also possible to configure all of the functions using a programmable device.

The second controller 170 is provided with a light emission detector 181 and a display controller 185 as functional blocks realized by the control program. These functional blocks schematically represent the functions realized by the processor 180 executing the control program using the blocks for the sake of convenience.

The light emission detector 181 detects the infrared light as the second signal light 155 emitted by the light emitting pen 30 from the taken image generated by the imager 150 performing the imaging. The light emission detector 181 regards a figure having a luminance no lower than a predetermined threshold value and a size within a predetermined range as the light emitted by the light emitting pen 30 out of the figures of the infrared light included in the image thus taken, and detects the position of the figure as the position where the light emitting pen 30 emits the light.

The light emission detector 181 discriminates the light emission sequences of the light emitting pen 30 based on the taken image taken a plurality of times. For example, the projector 100 and the light emitting pen 30 repeatedly perform an operation taking four phases, namely a first phase, a second phase, a third phase, and a fourth phase, as one cycle. The lengths of the first phase, the second phase, the third phase, and the fourth phase are set to the same length set in advance. The first phase is a synchronous phase, and a phase in which the transmitter 160 transmits the first signal light 165. The light emitting pen 30 judges the present phase as the first phase by the receiver 33 receiving the first signal light 165. The second phase and the fourth phase are each a phase of the position detection, wherein the light emitting pen 30 transmits the second signal light 155. In the second phase and the fourth phase, the light emission detector 181 detects the second signal light 155 transmitted by the light emitting pen 30 from the taken image to thereby detect the light emission position of the light emitting pen 30. The third phase is a notification phase in which the projector 100 is notified of whether or not the tip switch 34 is in the ON state. In the third phase, the light emitting pen 30 emits light in a light emission pattern set in advance. The light emitting pen 30 switches the light emission pattern in the third phase in accordance with whether the tip switch 34 is in the ON state or is in the OFF state.

An operation detector 183 detects an operation of the light emitting pen 30 based on the information of the light emission position of the light emitting pen 30 detected by the light emission detector 181, the information of the phase in which the light emission is detected, and so on.

The operation of the light emitting pen 30 detected by the operation detector 183 includes a selection operation of selecting an operation button, an icon, and so on included in the projection image 50 to be displayed on the projection surface 7A, a movement operation of moving the display position of the projection image 50, a drawing operation of drawing a character, a symbol, a figure, and so on, on the projection surface 7A.

When the light emission of the light emitting pen 30 has been detected at a certain position for a period no shorter than a certain time, the operation detector 183 determines that the selection operation for selecting this position has been detected. The operation detector 183 discriminates the operation button, the icon, and so on displayed at the position selected by the light emitting pen 30 based on the calibration data, and then notifies the display controller 185 of the operation button or the icon thus selected.

Further, when the movement of the light emission position of the light emitting pen 30 has been detected, the operation detector 183 determines whether or not the tip of the light emitting pen 30 has contact with the projection surface 7A. When the tip of the light emitting pen 30 has contact with the projection surface 7A, the operation detector 183 first detects the light emission position where the tip of the light emitting pen 30 makes contact with the projection surface 7A. When the light emission position where the contact with the projection surface 7A has been detected first is the display position of the projection image 50, the operation detector 183 determines that the movement operation of moving the display position of the projection image 50 has been made. Further, when the light emission position where the contact with the projection surface 7A has been detected first is a position where the projection image 50 is not displayed, the operation detector 183 determines that the drawing operation of drawing a character, a symbol, a figure, or the like has been made.

The display controller 185 controls the first controller 130 and the image projector 140 to display the projection image 50 on the projection surface 7A.

When the drawing operation has been detected by the operation detector 183, the display controller 185 generates the drawing data corresponding to a trajectory of the light emission by the light emitting pen 30. The drawing data is the data representing the trajectory as a line, and by displaying the drawing data on the projection surface 7A, the image such as a character, a symbol, or a figure drawn by the user operating the light emitting pen 30 is displayed on the projection surface 7A.

The display controller 185 outputs the resolution information for designating the resolution of the conversion image or the OSD image, and the coordinate information of the frame memory 131 on which the conversion image and the OSD image on which the resolution conversion has been performed, and the drawing data generated by the display controller 185 are drawn to the internal drawing generator 135.

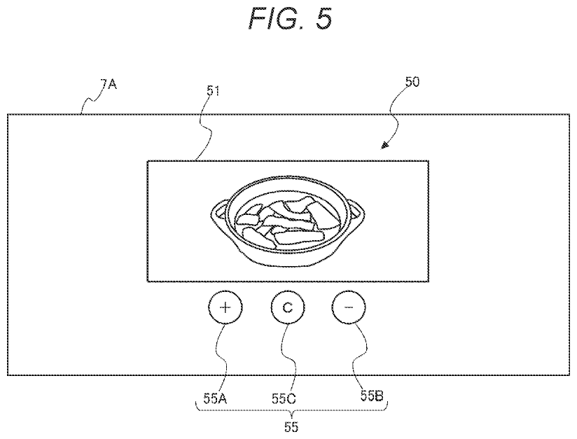

When the selection operation has been detected by the operation detector 183, the display controller 185 converts the projection image 50 in accordance with the selection operation thus detected. FIG. 5 is a diagram showing an example of the projection image 50 to be displayed on the projection surface 7A. The projection image 50 includes operation buttons 55 and so on besides a display image 51 as the image based on the image data supplied from the image supply device 10. The operation buttons 55 include an expansion button 55A, a reduction button 55B, and a minimization button 55C. The display image 51 corresponds to a first image, and a display size of the display image 51 to be displayed on the projection surface 7A corresponds to a first size. The expansion button 55A corresponds to a first button, and the reduction button 55B corresponds to a second button.

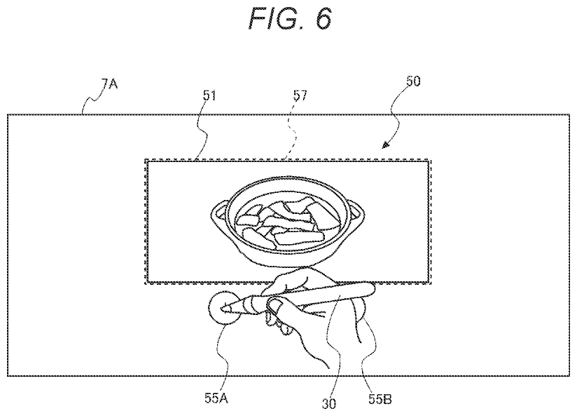

FIG. 6 is a diagram showing an example of a frame image 57.

The expansion button 55A is a button for expanding the display size of the display image 51. When an operation of selecting the expansion button 55A has been detected as the selection operation, the display controller 185 judges that an operation of expanding the display size of the display image 51 has been started, and displays the frame image 57 represented by dotted lines shown in FIG. 6 on the projection surface 7A. The frame image 57 is an image showing a display range of the display image 51. The frame image 57 can be a rectangular image corresponding to the shape of the display image 51 as shown in FIG. 6, or can also be a symbol or the like representing positions of four vertexes or two diagonal vertexes of the display image 51. Further, as the frame image 57, it is possible to use a rectangular figure which is made lower in opacity than the display image 51. The display size of the projection image 50 and the frame image 57 to be displayed on the projection surface 7A corresponds to the first size. The frame image 57 corresponds to an example of a second image.

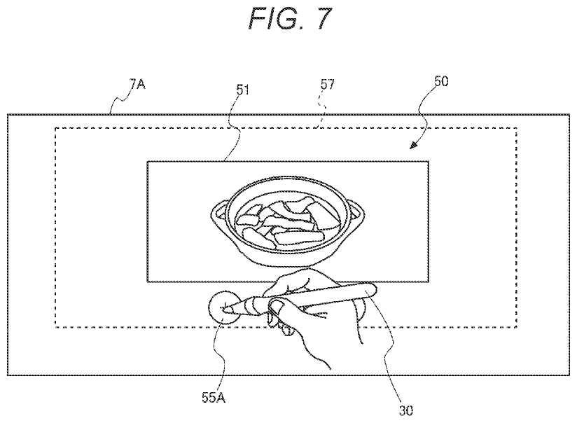

FIG. 7 is a diagram showing the frame image 57 with the display size expanded.

Then, during a period in which the selection operation of the expansion button 55A is continuously detected, the display controller 185 judges that the operation of expanding the display size of the display image 51 continues, and changes the display position of the frame image 57 based on the display image 51. Specifically, the display controller 185 displays the display image 51 without changing the display position, and displays the frame image 57 with the display position moved toward the outside of the display image 51 by a predetermined setting at a time. In other words, the display controller 185 expands the display size of the frame image 57 by a predetermined size. The display controller outputs the resolution information to the internal drawing generator 135, and expands the display size of the frame image 57 as the OSD image by a predetermined size.

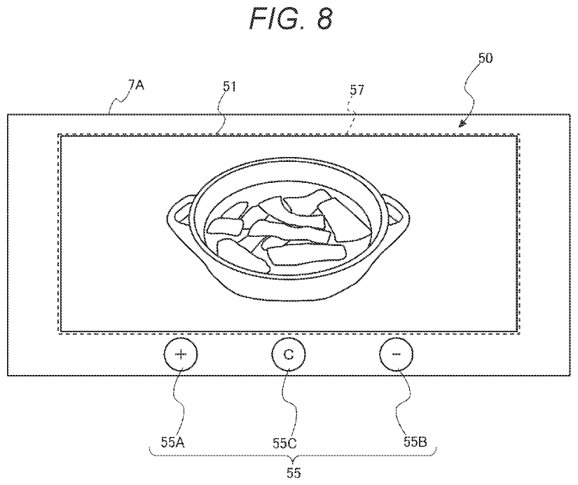

FIG. 8 is a diagram showing the display image 51 which has been expanded.

Further, when the operation of selecting the expansion button 55A stops being detected, namely when the light emission position of the light emitting pen 30 moves from the display positon of the expansion button 55A, the display controller 185 judges that the operation of expanding the display size of the display image 51 has been terminated, and stops the expansion or the display size of the frame image 57. The display size at the time point when stopping the expansion of the display size of the frame image 57 corresponds to an example of a second size.

Subsequently, the display controller converts the resolution of the conversion image with the same resolution information as the resolution information which has been instructed to the internal drawing generator 135 the last time. Thus, the display size of the display image 51 to be displayed on the projection surface 7A is converted in to the same size as the display size of the frame image 57.

The reduction button 55B is a button for reducing the display size of the display image 51. When an operation of selecting the reduction button 55B has been detected as the selection operation, the display controller 185 judges that an operation of reducing the display size of the display image 51 has been started, and displays the frame image 57 represented by the dotted lines shown in FIG. 6 on the projection surface 7A. The display size of the projection image 51 and the frame image 57 to be displayed on the projection surface 7A corresponds to an example of the first size.

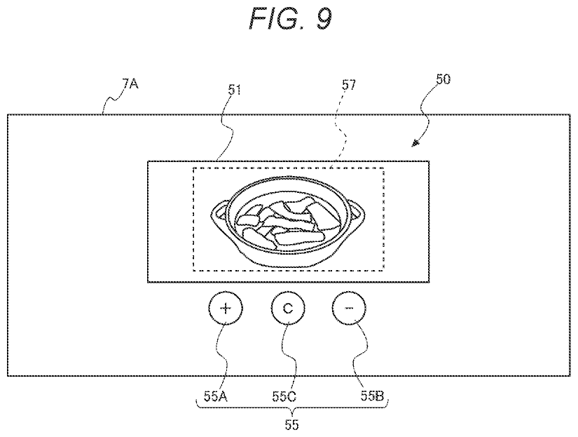

FIG. 9 is a diagram showing the frame image 57 with the display size reduced.

During a period in which the selection operation of the reduction button 55B is continuously detected, the display controller 185 judges that the operation of reducing the display size of the display image 51 continues, and changes the display position of the frame image 57 based on the display image 51. Specifically, the display controller 185 moves the display position of the frame image 57 toward the inside of the display image 51 by a predetermined setting at a time without changing the display position of the display image 51. In other words, the display controller 185 reduces the display size of the frame image 57 by a predetermined size. The display controller 185 outputs the resolution information to the internal drawing generator 135, and reduces the display size of the frame image 57 as the OSD image by a predetermined size.

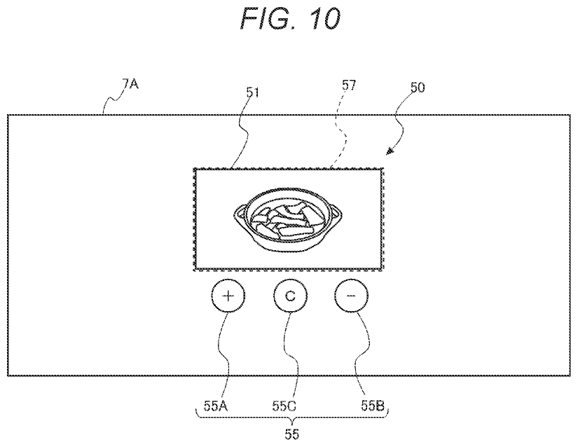

FIG. 10 is a diagram showing the display image 51 which has been reduced.

When the operation of selecting the reduction button 55B stops being detected, namely when the light emission position of the light emitting pen 30 moves from the display position of the reduction button 55B, the display controller 185 judges that the operation of reducing the display size of the display image 51 has been terminated, and stops the reduction of the display size of the frame image 57. The display size at the time point when stopping the reduction of the display size of the frame image 57 corresponds to an example of the second size. Subsequently, the display controller 185 converts the resolution of the conversion image with the same resolution information as the resolution information which has been instructed to the internal drawing generator 135 the last time. Thus, the display size of the display image 51 to be displayed on the projection surface 7A is converted in to the same size as the display size of the frame image 57.

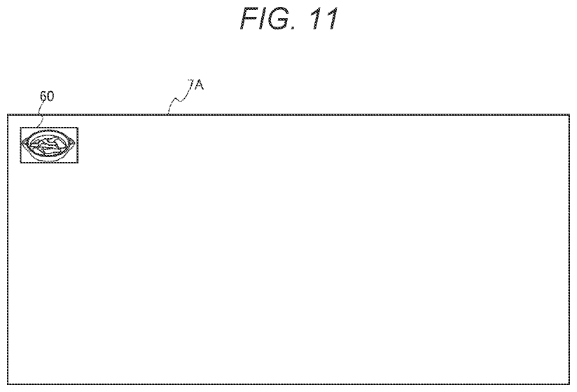

FIG. 11 is a diagram showing the projection surface 7A when the minimization button 55C has been held down.

The minimization button 55C is a button for minimizing the display size of the display image 51.

When an operation of selecting the minimization button 55C has been detected as the selection operation, the display controller 185 minimizes the display size of the display image 51. For example, the display controller 185 develops the conversion image which has been read out by the internal drawing generator 135 from the second storage 134 on the frame memory 131 without converting the resolution. Further, the position on the frame memory where the conversion image is developed is a position set in advance such as an initial position. Thus, on the projection surface 7A, there is displayed a thumbnail 60 of the display image 51. FIG. 11 shows a state in which the thumbnail 60 is displayed in an upper left area of the projection surface 7A set as the initial position.

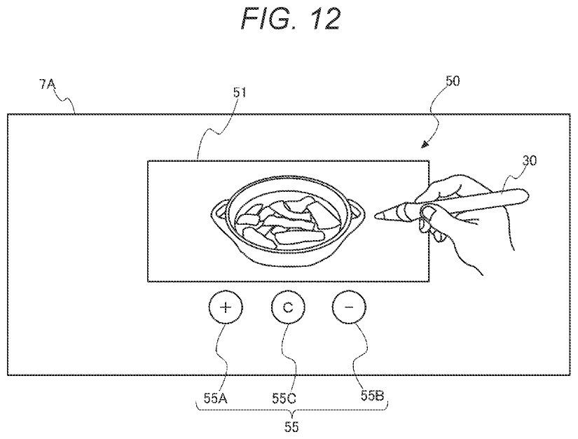

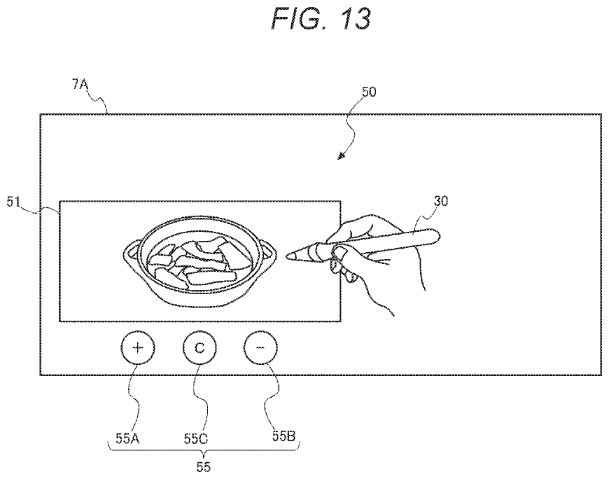

FIG. 12 is a diagram showing a display position of the projection image 50 which is not moved by the movement operation, and FIG. 13 is a diagram showing a display position of the projection image 50 which has been moved by the movement operation.

When the movement operation is detected by the operation detector 183, the display controller 185 moves the display position of the projection image 50 in accordance with the movement of the light emission position of the light emitting pen 30. FIG. 12 shows the projection image 50 which is not moved, and FIG. 13 shows the projection image 50 which has been moved by the movement operation.

Further, when the operation of the light emitting pen 30 has not been detected by the operation detector 183 for a period no shorter than a setting time set in advance, it is possible for the display controller 185 to erase the display, of the operation button 55 displayed on the projection surface 7A. When no operation is detected for a period no shorter than a certain time, it is assumed when the user is performing a work such as cooking while viewing the display image 51. Therefore, the display controller 185 erases unnecessary display such as the operation buttons 55 which degrades the visibility of the display image 51.

When a predetermined operation is detected, the display controller 185 displays the operation buttons 55 once erased.

For example, it is possible for the display controller 185 to display the projection image 50 including the operation buttons 55 when the display controller 185 has detected a hovering state as a state in which the tip 31 of the light emitting pen 30 does not have contact with the projection surface 7A for a period no shorter than a certain time. Further, it is possible for the display controller 185 to display the projection image 50 including the operation buttons 55 when the display controller 185 has detected the fact that the tip 31 of the light emitting pen 30 makes contact with the projection surface 7A in a state in which the operation buttons 55 are erased. Further, it is possible for the display controller 185 to display the projection image 50 including the operation buttons 55 when the display controller 185 has detected a gestural operation set in advance with the light emitting pen 30. For example, it is possible for the display controller 185 to display the projection image 50 including the operation buttons 55 when an operation of selecting any one of the four corners of the projection surface 7A with the light emitting pen 30 has been detected, or when an operation of double-clicking on the projection surface 7A with the light emitting pen 30 has been detected.

Further, when the supply of the image signal from the image supply device 10 stops, the display controller 185 erases the display of the display image 51 from the projection surface 7A, and also erases the display of the operation buttons 55 from the projection surface 7A.

Further, when the supply of the image signal from the image supply device 10 has resumed, the display controller 185 displays the display image 51 as the image based on the image data included in the image signal and the operation buttons 55 at a preset position set in advance. In other words, the display controller 185 displays the projection image 50 shown in FIG. 5 on the projection surface 7A. Further, when the supply of the image signal from the image supply device 10 has resumed, it is possible for the display controller 185 to display the thumbnail 60 in an upper left portion of the projection surface 7A as a preset position set in advance as shown in FIG. 11. Further, when the reception of the image signal has resumed, it is possible for the display controller 185 to display the display image 51 at the position where the display image 51 has once been displayed on the projection surface 7A.

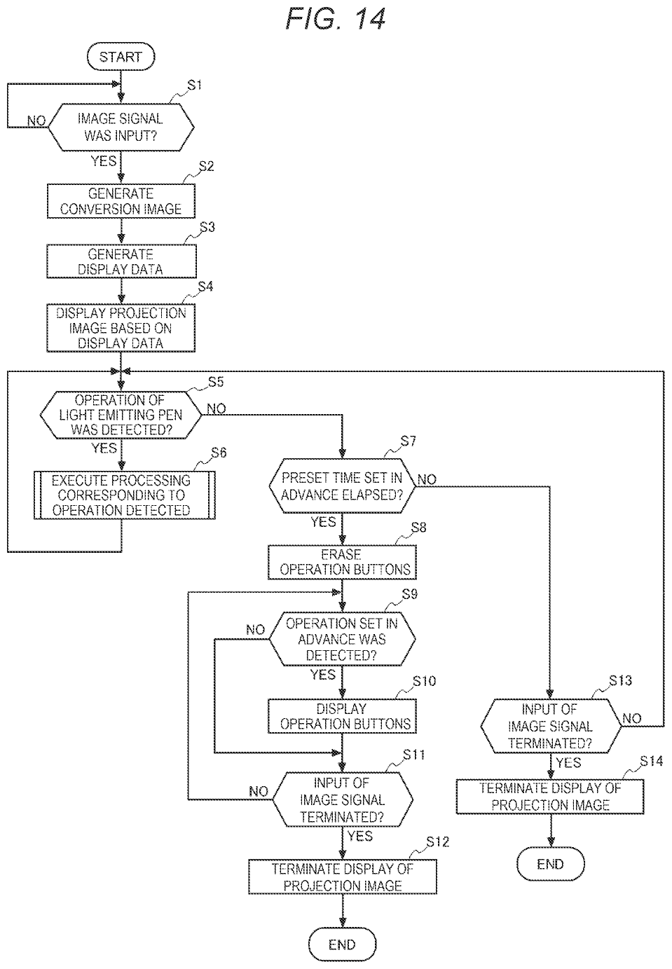

FIG. 14 through FIG. 17 are each a flowchart showing a control operation of the projector 100.

The control operation of the projector 100 will be described with reference to FIG. 14 through FIG. 17.

The second controller 170 determines (step S1) whether or not the image signal has been input to the I/F circuit 120. When the image signal is not input to the I/F circuit 120 (NO in the step S1), the second controller 170 stands ready to start the processing until the image signal is input to the I/F signal 120. The step S1 corresponds to a reception step.

When the image signal is input to the I/F circuit 120 (YES in the step S1), the second controller 170 makes the first controller 130 process the image data included in the image signal thus input to generate the display data. Specifically, the scaler 133 converts the resolution of the image data developed on the frame memory 131, scales the size of the image data to generate the conversion image, and stores the conversion image thus generated in the second storage 134 (step S2). The image synthesizer 136 synthesizes the conversion image and the OSD image read out from the second storage 134 by the internal drawing generator 135 to generate the display data (step S3). The image synthesizer 136 outputs the display data thus generated to the image projector 140 to make the image projector 140 display the projection image 50 including the display image as the image based on the display data and the operation buttons 55 on the projection surface 7A (step S4).

Then, the second controller 170 detects the infrared light as the second signal light 155 emitted by the light emitting pen 30 from the taken image generated by the imager 150 to thereby detect the light emission position. The second controller 170 detects the operation of the light emitting pen 30 based on the light emission position of the light emitting pen 30 thus detected and the information of the phase (step S5). When the operation of the light emitting pen 30 has not been detected (NO in the step S5), the second controller 170 determines whether or not a preset time set in advance has elapsed since the operation of the light emitting pen 30 stopped being detected (step S7).

When the preset time set in advance does not elapse (NO in the step S7), the second controller 170 determines whether or not the input of the image signal to the I/F circuit 120 has terminated (step S13). When the input of the image signal has terminated (YES in the step S13), the second controller 170 terminates the display of the projection image 50 (step S14). Further, when the input of the image signal does not terminate (NO in the step S13), the second controller 170 returns to the determination in the step S5.

Further, when the preset time set in advance has elapsed (YES in the step S7), the second controller 170 erases the display of the operation buttons 55 from the projection image 50 (step S8). Subsequently, the second controller 170 determines whether or not the operation of the light emitting pen 30 set in advance has been detected (step S9). The operation set in advance of the light emitting pen 30 includes, for example, an operation of continuing the hovering state for a period no shorter than a certain time, and the gestural operation set in advance.

When the second controller 170 has detected the operation of the light emitting pen 30 set in advance (YES in the step S9), the second controller 170 displays the operation buttons 55 once again, and displays the projection image 50 including the operation buttons 55 (step S10). Further, when the second controller 170 has not detected the operation of the light emitting pen 30 set in advance (NO in the step S9), the second controller 170 determines whether or not the input of the image signal to the I/F circuit 120 has terminated (step S11). When the input of the image signal has terminated (YES in the step S11), the second controller 170 terminates the display of the projection image 50 (step S12). Further, when the input of the image signal does not terminate (NO in the step S11), the second controller 170 returns to the determination in the step S9.

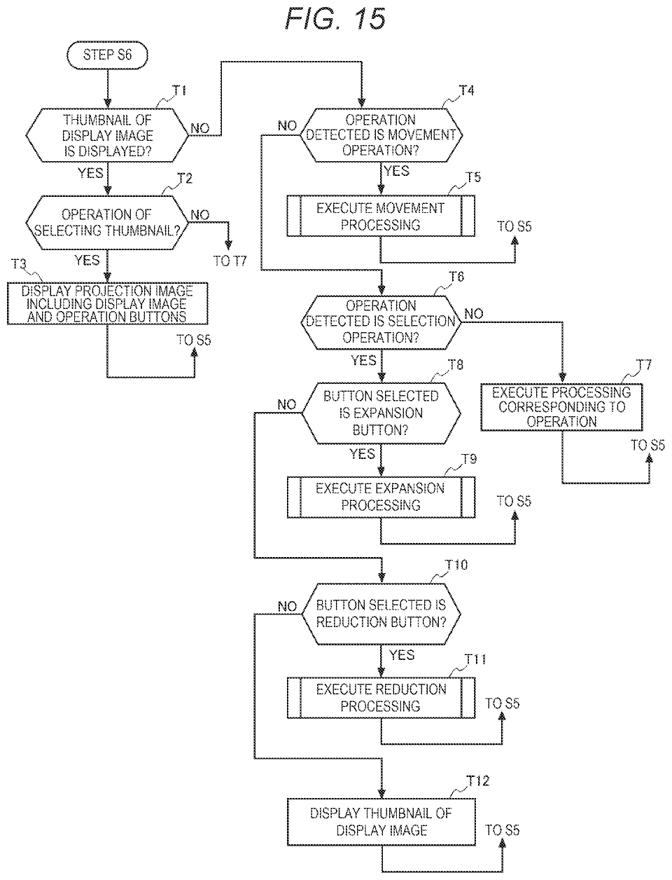

Further, when the second controller 170 has detected the operation of the light emitting pen 30 (YES in the step S5), the second controller 170 executes the processing corresponding to the operation thus detected (step S6). The details of the step S6 will be described with reference to the flowchart shown in FIG. 15.

FIG. 15 is a flowchart showing the details of the step S6.

The details of the step S6 will be described with reference to the flowchart shown in FIG. 15.

First, the second controller 170 determines whether or not the image displayed on the projection surface 7A is the thumbnail 60 of the display image 51 (step T1). When the image displayed on the projection surface 7A is the thumbnail 60 of the display image 51 (YES in the step T1), the second controller 170 determines whether or not the operation of the light emitting pen 30 detected in the step S5 is the operation of selecting the thumbnail 60 (step T2).

When the operation of the light emitting pen 30 is not the operation of selecting the thumbnail 60 (NO in the step T2), the second controller 170 makes the transition to the processing in the step T7 to execute the processing corresponding to the operation thus detected (step T7).

Further, when the operation of the light emitting pen 30 is the operation of selecting the thumbnail 60 (YES in the step T2), the second controller 170 displays (step T3) the projection image 50 including the display image 51 and the operation buttons 55 on the projection surface 7A, and then returns to the determination in the step S5.

When the image displayed on the projection surface 7A is not the thumbnail 60 of the display image 51 (NO in the step T1), namely the second controller 170 determines that the projection image 50 is displayed on the projection surface 7A, the second controller 170 determines whether or not the operation thus detected is the movement operation (step T4).

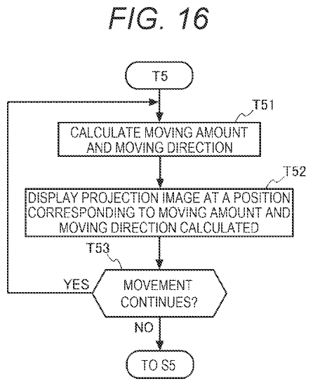

When the operation detected is the movement operation (YES in the step T5), the second controller 170 executes the movement processing corresponding to the movement operation thus detected (step T5). The details of the step T5 will be described with reference to FIG. 16.

When the operation thus detected is not the movement operation (NO in the step T4), the second controller 170 determines whether or not the operation thus detected is the selection operation (step T6). When the operation thus detected is riot the selection operation (NO in the step T6), the second controller 170 makes the transition to the processing in the step T7 to execute the processing corresponding to the operation thus detected such as the drawing operation (step T7).

Further, when the operation detected is the selection operation (YES in the T6), the second controller 170 determines whether or not the button thus selected is the expansion button 55A (step T8). When the button thus selected is the expansion button 55A (YES in the step T8), the second controller 170 executes the expansion processing of expanding the display size of the display image 51 (step T9).

Further, when the button thus selected is not the expansion button 55A (NO in the step T8), the second controller 170 determines whether or not the button thus selected is the reduction button 55B (step T10). When the button thus selected is the reduction button 55B (YES in the step T10), the second controller 170 executes the reduction processing of reducing the display size of the display image 51 (step T11).

Further, when the button thus selected is not the reduction button 55B (NO in the step T10), the second controller 170 determines that the button thus selected is the minimization button 55C to erase the display of the projection image 50, and then display the thumbnail 60 of the display image 51 (step T12).

FIG. 16 is a flowchart showing the details of the step T5.

First, the second controller 170 calculates a moving direction and a moving amount of the light emission position based on the coordinate before the movement and the coordinate after the movement of the light emission position of the light emitting pen 30 (step T51). The second controller 170 moves the display position of the projection image 50 in the moving direction thus calculated as much as the moving amount thus calculated (step T52). Then, the second controller 170 determines whether or not the movement of the light emission position of the light emitting pen 30 continues (step T53). When the movement of the light emission position of the light emitting pen 30 does not continue (NO in the step T53), the second controller 170 returns to the determination in the step S5, Further, when the movement of the light emission position of the light emitting pen 30 continues (YES in the step T53), the second controller 170 returns to the processing in the step T51 to calculate the moving amount and the moving direction.

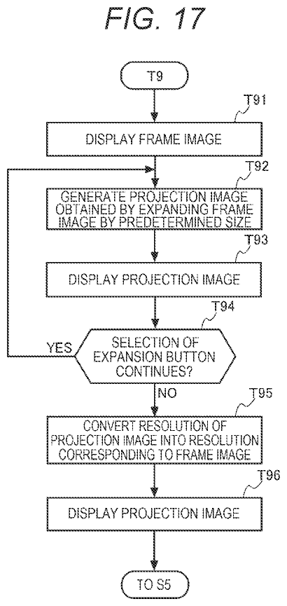

FIG. 17 is a flowchart showing the details of the step T9.

First, when the selection operation of selecting the expansion button 55A is detected, the second controller 170 displays the projection image 50 including the frame image 57 the same in size as the display image 51 (step T91). Then, the second controller 170 generates (step T92) the projection image 50 obtained by expanding the frame image 57 by a predetermined size, and then displays (step T93) the projection image 50 thus generated on the projection surface 7A. The step T92 corresponds to a second generation step, and the step T93 corresponds to a second display step.

Then, the second controller 170 determines whether or not the selection operation of the expansion button 55A continues (step T94). When the operation of the expansion button 55A continues (YES in the step T94), the second controller 170 returns to the processing in the step T92.

Further, when the second controller 170 has determined that the selection operation of the expansion button 55A has terminated (NO in the step T94), the second controller 170 changes the resolution of the display image 51 so that the display size of the display image 51 falls within the display range represented by the frame image 57 thus expanded (step T95). The step T95 corresponds to a third generation step. The second controller 170 displays the projection image 50 including the display image 51 the resolution of which has been changed on the projection surface 7A (step T96). The step T96 corresponds to a third display step.

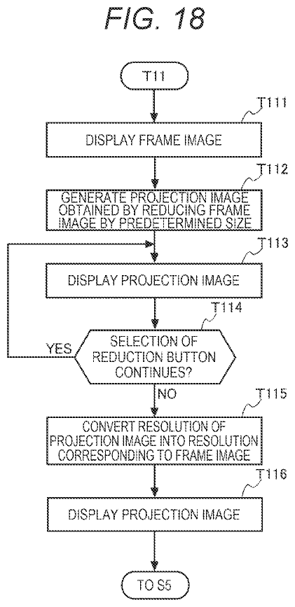

FIG. 18 is a flowchart showing the details of the step T11.

First, when the selection operation of selecting the reduction button 55B is detected, the second controller 170 displays the projection image 50 including the frame image 57 the same in size as the display image 51 (step T111). Then, the second controller 170 generates (step T112) the projection image 50 obtained by reducing the frame image 57 by a predetermined size, and then displays (step T113) the projection image 50 thus generated on the projection surface 7A.

Then, the second controller 170 determines whether or not the selection operation of the reduction button 55B continues (step T114). When the operation of the reduction button 55B continues (YES in the step T114), the second controller 170 returns to the processing in the step T112.

Further, when the second controller 170 has determined that the selection operation of the reduction button 55B has terminated (NO in the step T114), the second controller 170 changes the resolution of the display image 51 so that the display size of the display image 51 falls within the display range represented by the frame image 57 thus reduced. The step T115 corresponds to the third generation step. The second controller 170 displays the projection image 50 including the display image 51 the resolution of which has been changed on the projection surface 7A (step T116).

As described hereinabove, the second controller 170 of the projector 100 according to the present embodiment displays the display image 51 on the projection surface 7A in the first size.

When the second controller 170 has started the detection of the operation of changing the size of the display image 51, the second controller 170 displays the frame image 57 which has the first size and is different from the display image 51, and the display image 51 on the projection surface 7A.

Further, when the detection of the operation continues, the second controller 170 displays the display image 51 in the first size, and at the same time, displays the frame image 57 in the second size different from the first size based on the operation of changing the size of the display image 51.

Further, when the detection of the operation has terminated, the second controller 170 displays the display image 51 in the second size.

Therefore, when the detection of the operation continues, the display image 51 is displayed in the first size, and at the same time, the frame image 57 is displayed in the second size different from the first size based on the operation of changing the size of the display image 51, and therefore, during the period in which the detection of the operation continues, there is no chance that the size of the display image 57 is changed, and when a character or the like is displayed in the display image 51, it is possible to prevent the visibility of the display image 51 from deteriorating.

Further, when the frame image 57 is displayed in the second size different from the first size based on the operation of changing the size of the display image 51, and then the detection of the operation has terminated, since the display image 51 is displayed in the second size, the size of the display image 51 on which the operation has been performed becomes easy to recognize.

On the projection surface 7A, there is displayed the expansion button 55A of expanding the size of the display image 51.

When the second controller 170 displays the frame image 57 in the second size different from the first size, the second controller 170 displays the frame image 57 while expanding the frame image 57 in accordance with the period of time in which the operation has been performed.

Therefore, since the frame image 57 is displayed while being expanded in accordance with the period of time in which the expansion button 55A has been operated, the operation of expanding the size of the display image 51 becomes easy.

On the projection surface 7A, there is displayed the reduction button 553 of reducing the size of the display image 51.

When the second controller 170 displays the frame image 57 in the second size different from the first size, the second controller 170 displays the frame image 57 while reducing the frame image 57 in accordance with the period of time in which the operation has been performed.

Therefore, since the frame image 57 is displayed while being reduced in accordance with the period of time in which the reduction button 55B has been operated, the operation of reducing the size of the display image 51 becomes easy.

The second controller 170 generates the display image 51 based on the image signal received from the image supply device 10. When the reception of the image signal stops during the display of the display image 51 on the projection surface 7A, the second controller 170 stops displaying the display mace 51 on the projection surface 7A.

Therefore, when the supply of the image signal from the image supply device 10 stops, it is possible to stop the display of the display image 51 on the projection surface 7A.

When the reception of the image signal has resumed after the reception of the image signal has once stopped, the second controller 170 displays the display image 51 at the position where the display image 51 has once been displayed on the projection surface 7A.

Therefore, it is possible to make it easy to make the user recognize the fact that the supply of the image signal has resumed.

The embodiment described above is a preferred embodiment of the present disclosure. It should be noted that the embodiment described above is not a limitation, and a variety of modifications can be implemented within the scope or the spirit of the present disclosure.

For example, the I/F circuit 120 and the first controller 130 can be constituted by a single processor, or a plurality of processors, and so on. Further, the I/F circuit 120 and the first controller 130 can be constituted by a dedicated processing device such as an ASIC or an FPGA.

Further, in the embodiment described above, the light modulation element provided to the light modulation device 143 can be a transmissive liquid crystal panel or can also be a reflective liquid crystal panel. Further, it is also possible for the light modulation element to have a configuration using digital mirror devices, or to have a configuration having the digital mirror device and a color wheel combined with each other. Further, besides the liquid crystal panel or the DMD, configurations capable of modulating the light emitted by the light source can also be adopted as the light modulation device 143.

Further, each of the operators of the projector 100 shown in FIG. 2 is for showing the functional configuration, and a specific implementation configuration is not particularly limited. In other words, it is not necessarily required to install the hardware individually corresponding to each of the operators, but it is obviously possible to adopt a configuration of realizing the functions of the plurality of operators by single processor executing a program. Further, a part of the function realized by software in the embodiment described above can also be realized by hardware, and a part of the function realized by hardware can also be realized by software. Besides the above, the specific detailed configuration of each of other sections than the projector can arbitrarily be modified within the scope or the spirit of the present disclosure.

Further, the processing units of the flowcharts shown in FIG. 14 through FIG. 18 are obtained by dividing the processing of the projector 100 in accordance with major processing contents in order to make the processing of the projector 100 easy to understand. The scope of the present disclosure is riot limited by the way of the division or the names of the processing units shown in the flowcharts of FIG. 14 through FIG. 18. Further, the processing of the second controller 170 can also be divided into a larger number of processing units, or can also be divided so that one processing unit includes a larger amount of processing in accordance with the processing contents. Further, the processing sequences of the flowcharts described above are not limited to the illustrated example.

Further, when realizing the method of controlling the display device using a computer provided to the projector 100, it is also possible to configure the program to be executed by the computer as an aspect of a recording medium, an aspect of a transmission medium for transmitting the program. As the recording medium, there can be used a magnetic or optical recording medium, or a semiconductor memory device. Specifically, there can be cited a portable or rigid recording medium such as flexible disk, an HDD (Hard Disk Drive), a CD-ROM, a DVD, a Blu-ray disc, a magnetooptic disc, a flash memory, or a card-type recording medium. Further, the recording medium described above can also be a RAM, or a nonvolatile storage device such as a ROM or the HDD as an internal storage device provided to a server device. Blu-ray is a registered trademark.

What is claimed is:

1. A method of controlling a display device, comprising:
displaying a first image in a first size on a display surface;
displaying the first image and a second image which has the first size and is different from the first image on the display surface when an operation of changing a size of the first image is started;
displaying the first image in the first size on the display surface when the operation continues;
displaying the second image in a size different from the first size on the display surface based on the operation when the operation continues; and
displaying the first image in a second size based on the operation on the display surface when the operation terminates.

2. The method of controlling the display device according to claim 1, further comprising:
displaying a first button for expanding the size of the first image on the display surface, wherein
the operation is as operation of selecting the first button, and
the displaying the second image in the size different from the first size includes expanding the second image in accordance with a time length during which the operation continues.

3. The method of controlling the display device according to claim 1, further comprising:
displaying a second button for reducing the size of the first image on the display surface, wherein
the operation is an operation of selecting the second button, and
the displaying the second image in the size different from the first size includes reducing the second image in accordance with a time length during which the operation continues.

4. The method of controlling the display device according to claim 1, further comprising:
generating the first image based on an input signal received from an external device; and
stopping displaying the first image on the display surface when the reception of the input signal stops while displaying the first image on the display surface.

5. The method of controlling the display device according to claim 4, further comprising:
displaying the first image at a position on the display surface at which the first image was displayed before the reception of the input signal stopped when receiving the input signal after the reception of the input signal stopped.

6. A display device comprising:
a light modulation device; and
at least one processor programmed to execute
displaying, using the light modulation device, a first image in a first size on a display surface,
displaying, using the light modulation device, the first image and a second image which has the first size and is different from the first image on the display surface when an operation of changing a size of the first image is started,
displaying, using the light modulation device, the first image in the first size on the display surface when the operation continues,
displaying, using the light modulation device, the second image in a size different from the first size on the display surface based on the operation when the operation continues, and
displaying, using the light modulation device, the first image in a second size on the display surface based on the operation when the operation terminates.
